(19) United States
(12) Patent Application Publication
(10) Pub. No.: US 2022/0412160 A1
(43) Pub. Date: Dec. 29, 2022

(54) ROMAN SHADE

(71) Applicant: Wuxi JHT Homewares Co., Ltd., Wuxi (CN)

(72) Inventor: Yong WAN, Wuxi (CN)

(21) Appl. No.: 17/467,430

(22) Filed: Sep. 6, 2021

(30) Foreign Application Priority Data
Jun. 28, 2021 (CN) 202110717478.6

(51) Int. Cl. E06B 9/44

(52) U.S. Cl. CPC E06B 9/44; E06B 2009/445

(57) ABSTRACT

A roman shade includes a rolling assembly, two brackets, a beam, a fabric, and a roller shade; both ends of the rolling assembly are respectively supported by the two brackets and the two brackets are disposed on the beam. The beam includes a side wall connected to the fabric. The roller shade is attached to the back of the fabric. The roller shade includes a top portion secured to the rolling assembly. The rolling assembly includes a housing, a shaft, an end connector, a sealed fixing element, a spring, and a fixed part. The shaft is disposed in the housing. The housing includes an inner wall including a plurality of ribs disposed at intervals. The shaft includes a first end and a second end. The first end is rotatably disposed through the end connector and secured to one of the two brackets.

### CROSS-REFERENCE TO RELATED APPLICATIONS

Pursuant to 35 U.S.C. § 119 and the Paris Convention Treaty, this application claims foreign priority to Chinese Patent Application No. 202110717478.6 filed Jun. 28, 2021, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to the field of roman shades, and more particularly, to a cordless roman shade.

Roman shades are a type of window treatments used to block out the sun. Roman shades include a piece of fabric and a series of horizontal bars to support the fabric thereby forming a plurality of gentle folds. Existing roman shades are opened by a plurality of sets of cords or a beaded chain in conjunction with rollers. That is, the operation for opening the roman shades involves in cords, which is inconvenient.

An improved roman shade includes a sliding rail, a bracket, a piece of fabric, a tube, a power device, and a stop block. The stop block is configured to manually adjust the height of the shade. When the stop block is disposed in a high position unreachable by a user, the operation is inconvenient.

### SUMMARY

The disclosure provides a roman shade comprising a rolling assembly, two brackets, a beam, a fabric, and a roller shade; both ends of the rolling assembly are respectively supported by the two brackets and the two brackets are disposed on the beam; the beam comprises a side wall connected to the fabric; the roller shade is attached to a back of the fabric; the roller shade comprises a top portion secured to the rolling assembly.

The rolling assembly comprises a housing, a shaft, an end connector, a sealed fixing element, a spring, and a fixed part; the shaft is disposed in the housing; the housing comprises an inner wall comprising a plurality of ribs disposed at intervals; the shaft comprises a first end and a second end; the first end is rotatably disposed through the end connector and secured to one of the two brackets; the end connector is rotatably disposed in one end of the housing; the sealed fixing element is rotatably disposed in the second end of the shaft and is flexibly secured to the other bracket.

The spring and the fixed part are wrapped around the shaft; a first end of the spring is secured to the shaft and a second end of the spring is secured to the fixed part; the fixed part is movably disposed on the shaft.

The sealed fixing element, the end connector, and the fixed part each a plurality of grooves matched with the plurality of ribs.

In a class of this embodiment, the beam further comprises a first connector and the fabric comprises a second connector; the first connector is connected to the second connector in the form of a double-sided tape, a snap fastener, a zipper, or a hook-and-pile fastener.

In a class of this embodiment, the fabric comprises a bottom edge and a counterweight disposed on the bottom edge.

In a class of this embodiment, the shaft has a non-circular cross section.

In a class of this embodiment, the housing further comprises a slot; the roller shade comprises a clip strip corresponding to the slot.

In a class of this embodiment, a protrusion is disposed on an outer side of the sealed fixing element; the protrusion is rotatable with respect to the shaft and disposed in a hole of one of the two brackets; the first end of the shaft is inserted through the end connector into the hole.

In a class of this embodiment, a damper is disposed on the second end of the shaft; and the plurality of grooves matched with the plurality of ribs is further disposed on the damper.

In a class of this embodiment, a plurality of connecting rods is disposed in parallel on one side of the fabric close to the roller shade; and the roller shade is interspersed between the plurality of connecting rods.

In a class of this embodiment, the width of the fabric is greater than or equal to the length of the beam.

In a class of this embodiment, the roller shade comprises a plurality of cords or a fabric material wound on the housing.

The following advantages are associated with the roman shade of the disclosure:

1. The roman shade can be opened and lifted up quickly. Specifically, when the fabric is pulled down, under the weight of the counterweight and the weight of the fabric, the roman shade opens conveniently. When the counterweight is lifted up by hand, under the reacting force of the spring, the fabric is rolled up quickly by the sealed fixing element.

2. The roman shade comprises the counterweight and the damper. When the fabric is pulled to a certain height, the damper exhibits a damping effect, together with the weight of the counterweight, the housing stands in a balanced state, so that the fabric can stay in any height.

3. The rolling assembly is compact and runs smoothly, thus extending the service life of the roman shade.

4. The beam and the rolling assembly are covered by the fabric, exhibiting good visual aesthetic.

5. The components of the roman shade are detachable, which is conducive to the maintenance, assembly and disassembly of the roman shade.

### BRIEF DESCRIPTION OF THE DRAWINGS

FIG. 1 is a perspective view of a roman shade according to one embodiment of the disclosure;

FIG. 2 is an enlarged side view of a rolling assembly according to one embodiment of the disclosure;

FIG. 3 is a perspective view of a beam in conjunction with a hole of a bracket according to one embodiment of the disclosure;

FIG. 4 is a perspective view of a fabric in conjunction with a roller shade according to one embodiment of the disclosure; and

FIG. 5 is a front view of a roman shade according to one embodiment of the disclosure.

In the drawings, the following reference numbers are used: 1. Rolling assembly; 1.1.1. Slot; 1.1.2. Rib; 1.2.1. Shaft; 1.2.2. End connector; 1.2.3. Sealed fixing element; 1.2.4. Spring; 1.2.5. Damper; 1.2.6. Protrusion; 1.2.7. Fixed part; 2. Bracket; 2.1. Hole; 3. Beam; 3.1 First connector; 4. roller shade; 4.1. Clip strip; 5. Fabric; 5.1. Second connector; 6. Connecting rod; and 7. Counterweight.

### DETAILED DESCRIPTION

To further illustrate, embodiments detailing a roman shade are described below. It should be noted that the following embodiments are intended to describe and not to limit the disclosure.

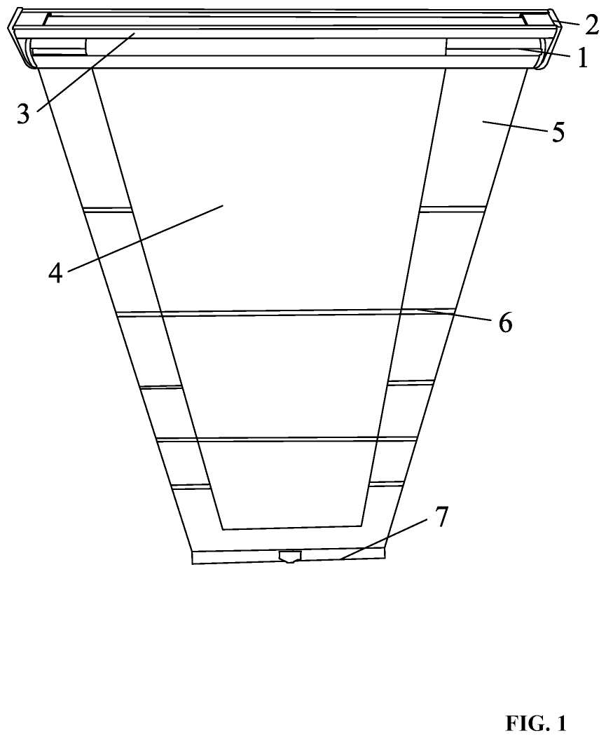

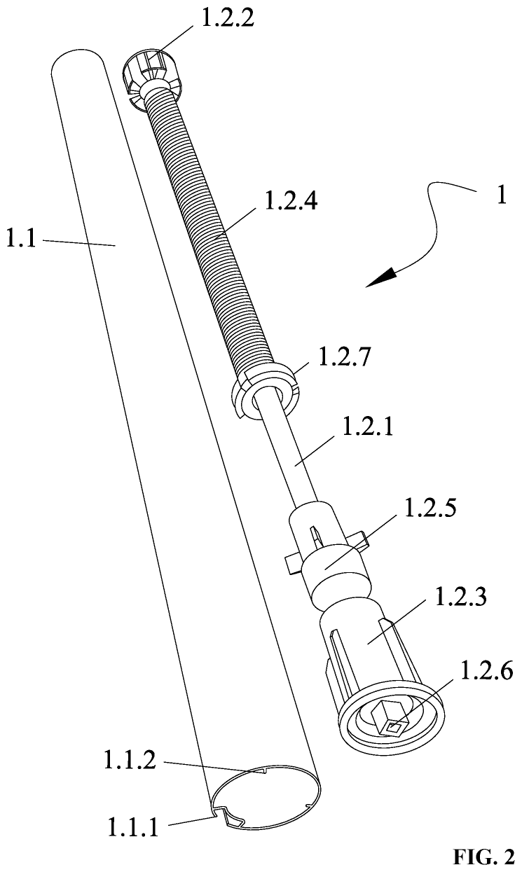

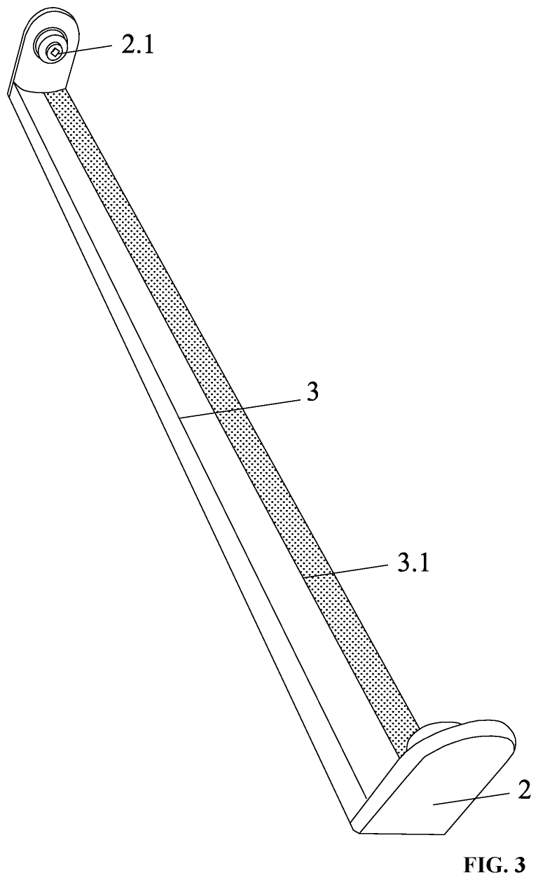

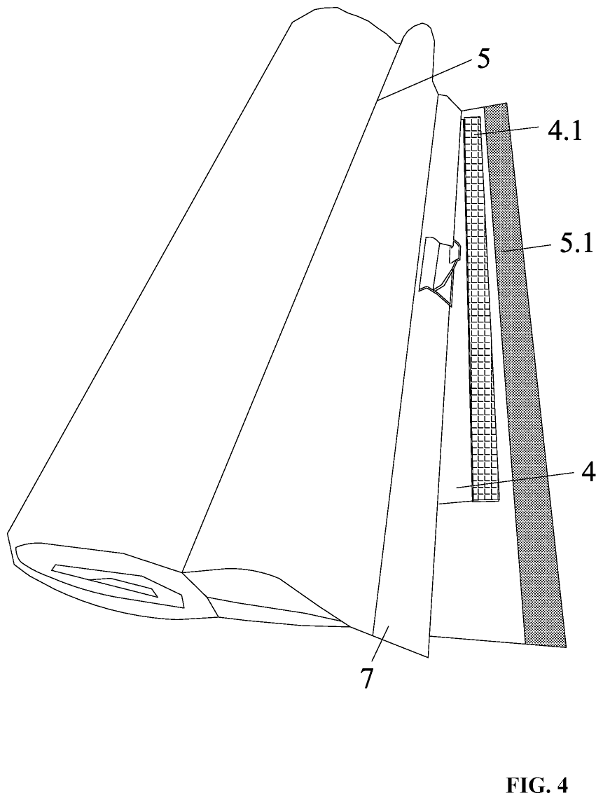

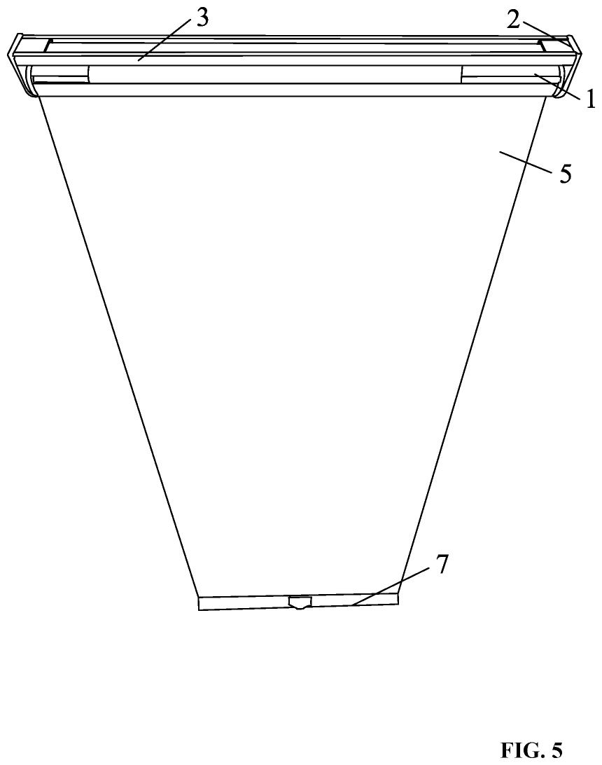

Referring to FIGS. 1-5, a roman shade comprises a rolling assembly 1, two brackets 2, a beam 3, a fabric 5, and a roller shade 4. Both ends of the rolling assembly 1 are respectively supported by the two brackets 2 and the two brackets are disposed on the beam 3. The beam 3 comprises a side wall connected to the fabric 5. The fabric 5 comprises a bottom edge and a counterweight 7 disposed on the bottom edge. The roller shade 4 comprises a bottom portion and a top portion. The bottom portion is attached to the back of the fabric 5 and the top portion is secured to the rolling assembly 1.

The beam 3 further comprises a first connector 3.1 and the fabric 5 further comprises a second connector 5.1. The first connector 3.1 is connected to the second connector 5.1 in the form of a double-sided tape, a snap fastener, a zipper, a hook-and-pile fastener, or other methods allowing for convenient assembly and disassembly of the beam and the fabric.

The rolling assembly 1 comprises a housing 1.1 and a shaft 1.2.1. Each of the two bracket 2 comprises a hole 2.1. The shaft 1.2.1 is disposed in the housing 1.1 and has a non-circular cross section, so that the rotational motion of the shaft 1.2.1 is limited by the hole 2.1. The housing 1.1 comprises a slot 1.1.1, and the inner wall of the housing comprises a plurality of ribs 1.1.2 disposed at intervals. The roller shade 4 comprises a clip strip 4.1 corresponding to the slot 1.1.1, so that the roller shade 4 is detachably connected to the rolling assembly 1.

The first end of the shaft 1.2.1 is rotatably inserted into an end connector 1.2.2. The end connector 1.2.2 is rotatably disposed in one end of the housing 1.1. A sealed fixing element 1.2.3 is rotatably disposed in the second end of the shaft 1.1. A protrusion 1.2.6 is disposed on the outer side of the sealed fixing element 1.2.3. The protrusion 1.2.6 is rotatable and disposed in the hole 2.1. The first end of the shaft 1.2.1 is inserted through the end connector 1.2.2 into the hole 2.1. The hole 2.1 is configured to limit the position of the shaft 1.2.1 and prevent the shaft 1.2.1 from rotating. The housing 1.1 is rotatable between the two brackets 2. When the housing rotates, the roller shade 4 is rolled up or unfolded, thereby driving the fabric 5 to open or close.

A spring 1.2.4 and a fixed part 1.2.7 are wrapped around the shaft 1.2.1. A first end of the spring 1.2.4 is secured to the shaft 1.2.1 and a second end of the spring 1.2.4 is secured to the fixed part 1.2.7. The fixed part 1.2.7 is movably disposed on the shaft 1.2.1. A damper 1.2.5 is disposed on the second end of the shaft 1.2.1. When the housing 1.1 rotates, the spring 1.2.4 provides a torsion. When the housing 1.1 is in a loose state, a reaction force of the torsion is applied to the housing 1.1 and relieved by the damper 1.2.5, thereby counterbalancing the gravity of the fabric 5 and the weight of the counterweight 7.

The sealed fixing element 1.2.3, the end connector 1.2.2, the damper 1.2.5, and the fixed part 1.2.7 each comprise a plurality of grooves matched with the plurality of ribs 1.1.2, so that the sealed fixing element 1.2.3, the end connector 1.2.2, the damper 1.2.5, and the fixed part 1.2.7 can rotate synchronously with the housing 1.1. When pulled downward, the fabric 5 drives the roller shade 4 to move. Then the roller shade 4 drives the housing 1.1 to rotate, causing the fixed part 1.2.7 and the damper 1.2.5 to rotate as well. Since one end of the spring 1.2.4 is stationary with respect to the shaft 1.2.1, when the fixed part 1.2.7 rotates, the spring 1.2.1 provides the torsion, which causes the housing 1.1 to provide a reaction force and rotate in the opposite direction. The reaction force of the housing 1.1 counterbalances with the damping force from the damper 1.2.5 and the weight of the counterweight 7, so that the fabric 5 is quickly opened to any height. The counterweight 7 is lifted up by hand to break the counterbalance and the spring 1.2.4 exerts the reaction force on the sealed fixing element 1.2.3, so that the fabric 5 is quickly closed.

A plurality of connecting rods 6 is disposed in parallel on one side of the fabric 5 close to the roller shade 4. The roller shade 4 is interspersed between the plurality of connecting rods 6, which makes the fabric 5 and the roller shade 4 close to each other, simultaneously rolling up the fabric 5 and the roller shade 4 into the housing 1.1.

The width of the fabric 5 is greater than or equal to the length of the beam 3 to cover the beam 3, exhibiting a visual aesthetic.

The roller shade 4 comprises a plurality of cords or a fabric material wound on the housing 1.1.

In other embodiments, the components of the roman shade are applied to a roller shade.

It will be obvious to those skilled in the art that changes and modifications may be made, and therefore, the aim in the appended claims is to cover all such changes and modifications.

The invention claimed is:

1. A roman shade, comprising:
a rolling assembly, the rolling assembly comprising a housing, a shaft, an end connector, a sealed fixing element, a spring, and a fixed part;
two brackets;
a beam;
a fabric; and
a roller shade;
wherein
both ends of the rolling assembly are respectively supported by the two brackets and the two brackets are disposed on the beam; the beam comprises a side wall connected to the fabric; the roller shade is attached to a back of the fabric; the roller shade comprises a top portion secured to the rolling assembly;
the shaft is disposed in the housing; the housing comprises an inner wall comprising a plurality of ribs disposed at intervals; the shaft comprises a first end and a second end; the first end is rotatably disposed through the end connector and secured to one of the two brackets; the end connector is rotatably disposed in one end of the housing; the sealed fixing element is rotatably disposed in the second end of the shaft and is flexibly secured to the other bracket;
the spring and the fixed part are wrapped around the shaft; a first end of the spring is secured to the shaft and a second end of the spring is secured to the fixed part; the fixed part is movably disposed on the shaft; and
the sealed fixing element, the end connector, and the fixed part each comprise a plurality of grooves matched with the plurality of ribs.

2. The roman shade of claim 1, wherein the beam further comprises a first connector and the fabric comprises a second connector; the first connector is connected to the second connector in the form of a double-sided tape, a snap fastener, a zipper, or a hook-and-pile fastener.

3. The roman shade of claim 1, wherein the fabric comprises a bottom edge and a counterweight disposed on the bottom edge.

4. The roman shade of claim 1, wherein the shaft has a non-circular cross section.

5. The roman shade of claim 1, wherein the housing comprises a slot, and the roller shade comprises a clip strip corresponding to the slot.

6. The roman shade of claim 4, wherein a protrusion is disposed on an outer side of the sealed fixing element; the protrusion is rotatable with respect to the shaft and disposed in a hole of one of the two brackets; and the first end of the shaft is inserted through the end connector into the hole.

7. The roman shade of claim 5, wherein a damper is disposed on the second end of the shaft, and the plurality of grooves matched with the plurality of ribs is disposed on the damper.

8. The roman shade of claim 1, wherein a plurality of connecting rods is disposed in parallel on one side of the fabric close to the roller shade; and the roller shade is interspersed between the plurality of connecting rods.

9. The roman shade of claim 1, wherein a width of the fabric is greater than or equal to a length of the beam.

10. The roman shade of claim 1, wherein the roller shade comprises a plurality of cords or a fabric material wound on the housing.
